(19) United States
(12) Patent Application Publication
(10) Pub. No.: US 2024/0005228 A1
(43) Pub. Date: Jan. 4, 2024

(54) MAINTENANCE STAFF MANAGEMENT APPARATUS, MAINTENANCE STAFF MANAGEMENT METHOD, AND STORAGE MEDIUM

(71) Applicant: Fujitsu Limited, Kawasaki-shi (JP)

(72) Inventor: Tetsuya YOKOYAMA, Kawasaki (JP)

(73) Assignee: Fujitsu Limited, Kawasaki-shi (JP)

(21) Appl. No.: 18/193,710

(22) Filed: Mar. 31, 2023

(30) Foreign Application Priority Data
Jun. 29, 2022 (JP) 2022-104553

(51) Int. Cl. G06Q 10/0631

(52) U.S. Cl. CPC G06Q 10/063112

(57) ABSTRACT

A maintenance staff management apparatus includes one or more memories; and one or more processors coupled to the one or more memories and the one or more processors configured to: acquire first data including maintenance results of different models of devices installed in a plurality of stations under jurisdiction of a plurality of bases for each base, acquire second data including a skill possessed by a maintenance staff of the device for the model, acquire a number of persons of the maintenance staff for each of the bases desired for maintenance of the device based on the maintenance results and the skill, and output the number of persons to a display apparatus as data associated with a combination of the device and the base.

### CROSS-REFERENCE TO RELATED APPLICATION

This application is based upon and claims the benefit of priority of the prior Japanese Patent Application No. 2022-104553, filed on Jun. 29, 2022, the entire contents of which are incorporated herein by reference.

### FIELD

The embodiments discussed herein are related to a maintenance staff management apparatus, a maintenance staff management method, and a storage medium.

### BACKGROUND

It is known that, when a failure occurs in an apparatus or a system, a worker who has an available schedule is searched for, whether the searched worker has knowledge or experience about a restoration work is confirmed, and the worker who has the knowledge or experience is selected as a worker for the restoration work. It is also known that a person in charge of handling an event such as a failure that occurs in an information system has to have a predetermined skill for handling the event.

Japanese Laid-open Patent Publication No. 2020-154749 and Japanese Laid-open Patent Publication No. 2020-113022 are disclosed as related art.

### SUMMARY

According to an aspect of the embodiments, a maintenance staff management apparatus includes one or more memories; and one or more processors coupled to the one or more memories and the one or more processors configured to: acquire first data including maintenance results of different models of devices installed in a plurality of stations under jurisdiction of a plurality of bases for each base, acquire second data including a skill possessed by a maintenance staff of the device for the model, acquire a number of persons of the maintenance staff for each of the bases desired for maintenance of the device based on the maintenance results and the skill, and output the number of persons to a display apparatus as data associated with a combination of the device and the base.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a maintenance staff management system;

FIG. 2 is a diagram illustrating an example of a hardware configuration of a maintenance staff management apparatus;

FIG. 3 is a diagram illustrating an example of a functional configuration of the maintenance staff management apparatus;

FIG. 4 is a diagram illustrating an example of asset data;

FIG. 5 is a diagram illustrating an example of maintenance data;

FIG. 6 is a diagram illustrating an example of skill data;

FIG. 7 is a diagram illustrating an example of building data;

FIG. 8 is a diagram illustrating an example of movement time data;

FIG. 9 is a flowchart illustrating an example of operation of an acquisition unit;

FIG. 10 is a processing sequence diagram illustrating an example of each operation of an input and output unit, a distribution unit, an estimation unit, and a calculation unit;

FIG. 11 is a flowchart illustrating an example of first processing;

FIG. 12 is a flowchart illustrating an example of distribution processing;

FIG. 13A is a diagram illustrating an example of a base-based station list;

FIG. 13B is a diagram illustrating another example of the base-based station list;

FIG. 14 is a diagram for explaining a relationship between locations of stations and bases;

FIG. 15 is a flowchart illustrating an example of estimation processing;

FIG. 16A is a diagram illustrating an example of first intermediate data according to a first embodiment;

FIG. 16B is a diagram illustrating an example of second intermediate data according to the first embodiment;

FIG. 16C is a diagram illustrating an example of base-based maintenance result data according to the first embodiment;

FIG. 17A is a diagram illustrating an example of model-based operation prospect data;

FIG. 17B is a diagram illustrating another example of the model-based operation prospect data;

FIG. 18 is a flowchart illustrating an example of calculation processing;

FIG. 19A is a diagram illustrating an example of number-of-persons data in which a target number of persons is set;

FIG. 19B is a diagram illustrating an example of number-of-persons data in which a current number of persons and a desired number of persons are set;

FIG. 19C is a diagram illustrating an example of final number-of-persons data according to the first embodiment;

FIG. 20 is a flowchart illustrating an example of second processing;

FIG. 21 is a diagram illustrating an example of a confirmation screen;

FIG. 22A is a diagram illustrating an example of first intermediate data according to a second embodiment;

FIG. 22B is a diagram illustrating an example of second intermediate data according to the second embodiment;

FIG. 22C is a diagram illustrating an example of base-based maintenance result data according to the second embodiment;

FIG. 23A is a diagram illustrating an example of model-based operation prospect data according to the second embodiment;

FIG. 23B is a diagram illustrating an example of number-of-persons data in which a target number of persons based on an operation prospect and a target number of persons based on a correction factor are set; and

FIG. 23C is a diagram illustrating an example of final number-of-persons data according to the second embodiment.

### DESCRIPTION OF EMBODIMENTS

As communication devices used for providing a communication service, in addition to the latest models, old models that have been in operation for decades are mixed. Such various models of communication devices are installed in a building called a station. The station is provided not only in an urban area but also in various areas such as isolated islands and mountains.

Although the communication device is installed in the station, a maintenance staff in charge of a maintenance work of the communication device is not present in the station, and the maintenance staff stays or waits at an office called a base that has jurisdiction over the station. For example, in a case where a failure occurs in the communication device, the maintenance staff moves from the base to the station and performs a maintenance work for the communication device. From a viewpoint that the stations are provided in various areas, a plurality of bases have jurisdiction over a plurality of stations for each base.

In a case of maintenance of the various models of communication devices, it is desirable that a maintenance staff possesses a skill capable of handling all the communication devices. However, in a case where the maintenance staff possesses the skill capable of handling all the communication devices, there is a problem that time and cost until the maintenance staff possesses the skill increase.

For this reason, a person in charge who plans disposition of the maintenance staff at bases appropriately disposes a desired maintenance staff at each base based on the experience of the person in charge himself/herself, and performs support to the maintenance staff for possessing the skill as demanded, thereby handling the problem. However, a situation in which a maintenance staff is disposed, such as an increase or decrease in the number of communication devices, introduction of a new model, and a change in the maintenance staff, changes from hour to hour. For this reason, it is difficult to appropriately dispose a maintenance staff based on the experience of the person in charge himself/herself.

Accordingly, in one aspect, it is an object to provide a maintenance staff management apparatus, a maintenance staff management method, and a maintenance staff management program that support disposition of a maintenance staff possessing a skill demanded for maintenance of devices of different models at each base.

Embodiments for carrying out the present disclosure will be described below with reference to the drawings.

### First Embodiment

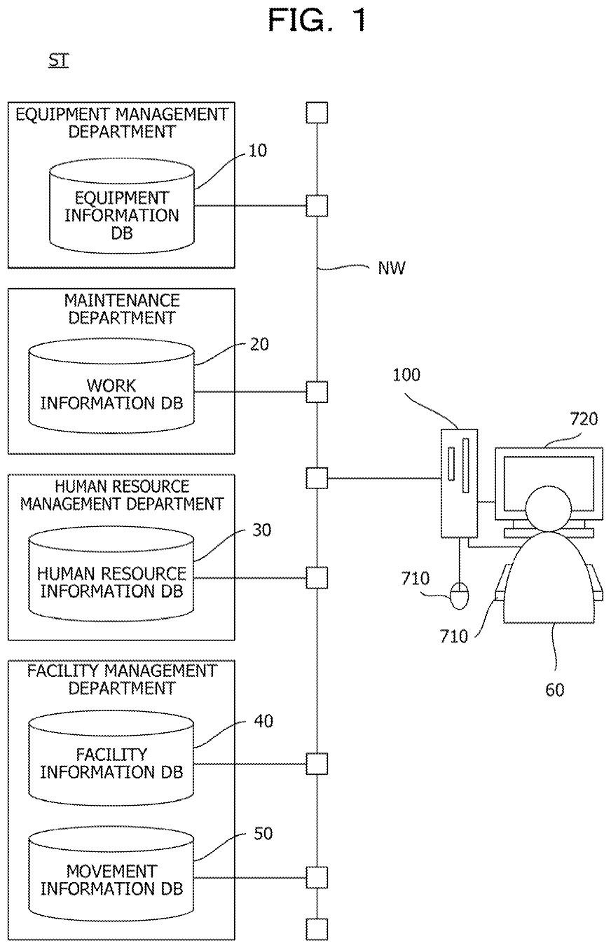

As illustrated in FIG. 1, a maintenance staff management system ST includes an equipment information database (DB) 10, a work information DB 20, a human resource information DB 30, a facility information DB 40, a movement information DB 50, and a maintenance staff management apparatus 100. The equipment information DB 10, the work information DB 20, the human resource information DB 30, the facility information DB 40, the movement information DB 50, and the maintenance staff management apparatus 100 are coupled to each other by a communication network NW. The communication network NW includes, for example, one or both of a local area network (LAN) and the Internet.

The equipment information DB 10 is managed by an equipment management department of a company and is periodically or non-periodically updated. The work information DB 20 is managed by a maintenance department of a company and is periodically or non-periodically updated. The human resource information DB 30 is managed by a human resource management department of a company and is periodically or non-periodically updated. The facility information DB 40 and the movement information DB 50 are managed by a facility management department of a company and are periodically or non-periodically updated. For example, the maintenance staff management apparatus 100 is managed by a department that manages a maintenance staff, such as a planning department or a general affairs department of a company. These companies may be the same or different from each other. For example, the maintenance staff management apparatus 100 may be managed by a parent company, and each DB such as the equipment information DB 10 and the work information DB 20 may be managed by a subsidiary company.

The equipment information DB 10 stores equipment information including a model of a communication device (hereafter, simply referred to as a device) installed and operated in each station, a quantity of each model, a specification of the device, and the like. The equipment information is updated in accordance with installation, removal, or the like of a device. The device according to the present embodiment includes an optical communication device related to optical communication such as a reconfigurable optical add/drop multiplexer (ROADM) or a transponder, but does not include a wireless device (for example, a wireless device for wide area communication) having a service life shorter than that of the optical communication device. Because the service life of the wireless device is shorter than that of the optical communication device, it is assumed that a frequency of replacement of the wireless device is high and there is no significant difference between models of the wireless devices. For this reason, it is assumed that, when a young maintenance staff who has little maintenance experience possesses a skill, the maintenance staff may maintain the wireless device by the skill. On the other hand, the optical communication device has a longer service life than the wireless device, and thus there are various models of optical communication devices. For this reason, there is a case where, unless it is a veteran maintenance staff who has long maintenance experience, maintenance of the optical communication device may not be performed. As described above, unlike the wireless devices, the optical communication device has a long service life, and the maintenance staff may be demanded to have a specific skill for the model.

The work information DB 20 stores work information including a maintenance work history of a device. A record is added to the work information every time the maintenance work is completed. The maintenance work history includes a maintenance work date, a name and a number of devices targeted for the maintenance work, a name of a station in which the device is installed, a name of a maintenance staff who has performed the maintenance work, and the like.

The human resource information DB 30 stores human resource information including a skill possessed by a maintenance staff, a base name of a base where the maintenance staff stays, waits, or works, a birth date or years of the maintenance staff, and the like. For example, the human resource information is updated based on changes and skill learning of the maintenance staff. The facility information DB 40 stores facility information including a building name, a type, a location, a scale, a telephone number, and the like of a building such as a station or a base. The facility information is updated when the number of buildings increases or decreases. The movement information DB 50 stores movement information including a movement time between buildings (for example, between a station and a base, between bases, or the like), a road used during the movement, transportation, and the like. The movement information is updated, for example, when new roads are built or when transportation timetables are revised.

The maintenance staff management apparatus 100 periodically or non-periodically accesses the equipment information DB 10, the work information DB 20, the human resource information DB 30, the facility information DB 40, and the movement information DB 50, and acquires the equipment information, the work information, the human resource information, the facility information, and the movement information. For example, the maintenance staff management apparatus 100 extracts and acquires a part of the equipment information, a part of the work information, a part of the human resource information, a part of the facility information, and a part of the movement information in accordance with settings or operations. For example, the maintenance staff management apparatus 100 does not acquire all of each of the equipment information, the work information, the human resource information, the facility information, and the movement information. As described above, since the maintenance staff management apparatus 100 executes various types of processing described later by using the part of equipment information, the part of work information, the part of human resource information, the part of facility information, and the part of movement information that are acquired, it is possible to reduce a processing load as compared with a case where all of the equipment information, the work information, the human resource information, the facility information, and the movement information are acquired.

An input apparatus 710 and a display apparatus 720 are coupled to the maintenance staff management apparatus 100. When a user 60 who is a person in charge of planning the disposition of the maintenance staff operates the input apparatus 710 to request the maintenance staff management apparatus 100 to execute processing, the maintenance staff management apparatus 100 executes various processing and outputs an execution result to the display apparatus 720. For example, the maintenance staff management apparatus 100 outputs, to the display apparatus 720, a confirmation screen including, as the execution result, data serving as a reference for the disposition plan of the maintenance staff. By confirming the confirmation screen, the user 60 may plan appropriate disposition of the maintenance staff at the base. For example, in a case where a maintenance staff possessing a skill capable of handling a device installed in a certain station is insufficient at a target base that has jurisdiction over a station, the user 60 may make a plan for disposing the maintenance staff possessing the skill from another base to this target base. The user 60 may prompt a maintenance staff who does not possess this skill to learn this skill.

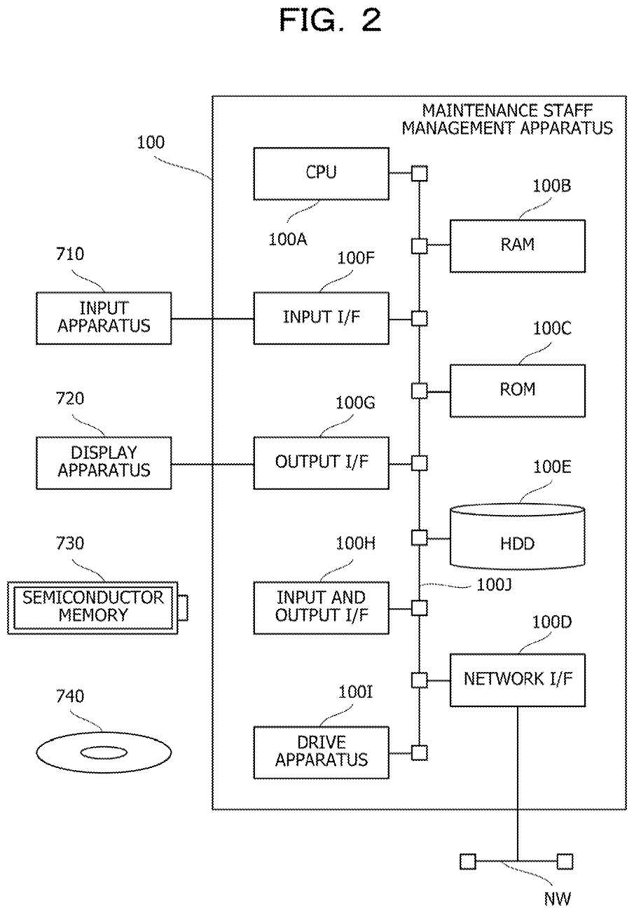

A hardware configuration of the maintenance staff management apparatus 100 will be described with reference to FIG. 2. Because the hardware configuration of the equipment information DB 10, the work information DB 20, the human resource information DB 30, the facility information DB 40, and the movement information DB 50 basically has the same hardware configuration as the hardware configuration of the maintenance staff management apparatus 100, detailed description thereof will be omitted.

The maintenance staff management apparatus 100 includes a central processing unit (CPU) 100A as a processor, and a random-access memory (RAM) 100B and a read-only memory (ROM) 100C as memories. The maintenance staff management apparatus 100 includes a network interface (I/F) 100D and a hard disk drive (HDD) 100E. A solid-state drive (SSD) may be adopted instead of the HDD 100E.

The maintenance staff management apparatus 100 may include at least one of an input I/F 100F, an output I/F 100G, an input and output I/F 100H, and a drive apparatus 100I as appropriate. The CPU 100A, the RAM 100B, the ROM 100C, the network I/F 100D, the HDD 100E, the input I/F 100F, the output I/F 100G, the input and output I/F 100H, and the drive apparatus 100I are coupled to each other by an internal bus 100J. For example, the maintenance staff management apparatus 100 may be implemented by a computer.

The input apparatus 710 is coupled to the input I/F 100F. Examples of the input apparatus 710 include a keyboard, a mouse, a touch panel, and the like. The display apparatus 720 is coupled to the output I/F 100G. Examples of the display apparatus 720 include a liquid crystal display and the like. A semiconductor memory 730 is coupled to the input and output I/F 100H. Examples of the semiconductor memory 730 include a Universal Serial Bus (USB) memory, a flash memory, and the like. The input and output I/F 100H reads a maintenance staff management program stored in the semiconductor memory 730. The input I/F 100F and the input and output I/F 100H include, for example, a USB port. The output I/F 100G includes, for example, a display port.

A portable-type recording medium 740 is inserted into the drive apparatus 100I. Examples of the portable-type recording medium 740 include a removable disc such as a compact disc (CD)-ROM or a Digital Versatile Disc (DVD). The drive apparatus 100I reads the maintenance staff management program recorded in the portable-type recording medium 740. The network I/F 100D includes, for example, a local area network (LAN) port, a communication circuit, and the like. The network I/F 100D is coupled to the communication network NW.

The maintenance staff management program stored in at least one of the ROM 100C, the HDD 100E, and the semiconductor memory 730 is temporarily stored in the RAM 100B by the CPU 100A. The maintenance staff management program recorded in the portable-type recording medium 740 is temporarily stored in the RAM 100B by the CPU 100A. By executing the stored maintenance staff management program by the CPU 100A, the CPU 100A implements various functions described later, and also executes a maintenance staff management method including various processing described later. The maintenance staff management program is sufficient as long as it is in accordance with a processing sequence diagram and a flowchart described later.

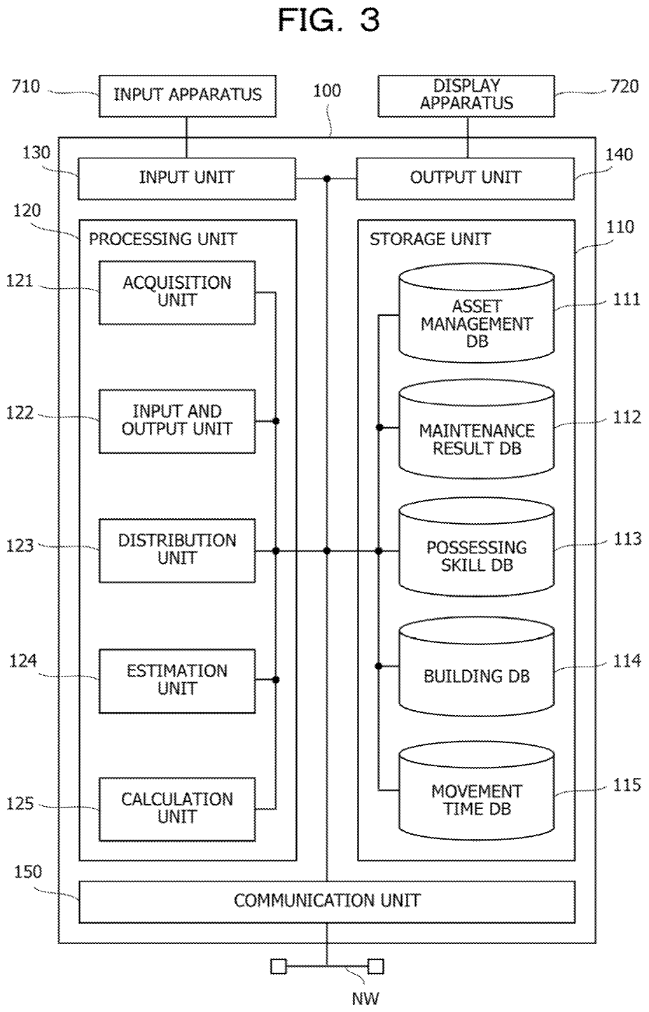

The functional configuration of the maintenance staff management apparatus 100 will be described with reference to FIGS. 3 to 8. FIG. 3 illustrates main parts of the functions of the maintenance staff management apparatus 100. Details of the functions of the maintenance staff management apparatus 100 will be described when the operation of the maintenance staff management apparatus 100 is described as appropriate.

The maintenance staff management apparatus 100 includes a storage unit 110, a processing unit 120, an input unit 130, an output unit 140, and a communication unit 150. The storage unit 110 may be implemented by one or both of the RAM 100B and the HDD 100E described above. The processing unit 120 may be implemented by the CPU 100A described above. The input unit 130 may be implemented by the input I/F 100F. The output unit 140 may be implemented by the output I/F 100G. The communication unit 150 may be implemented by the network I/F 100D described above.

The storage unit 110, the processing unit 120, the input unit 130, the output unit 140, and the communication unit 150 are coupled to each other. The storage unit 110 includes an asset management DB 111, a maintenance result DB 112, and a possessing skill DB 113. The asset management DB 111 is an example of a third storage unit. The maintenance result DB 112 is an example of a first storage unit. The possessing skill DB 113 is an example of a second storage unit. The storage unit 110 includes a building DB 114 and a movement time DB 115. The movement time DB 115 is an example of a fourth storage unit. On the other hand, the processing unit 120 includes an acquisition unit 121, an input and output unit 122, a distribution unit 123, an estimation unit 124, and a calculation unit 125. The input and output unit 122 is an example of an output unit. The estimation unit 124 is an example of an estimation unit. The calculation unit 125 is an example of a calculation unit.

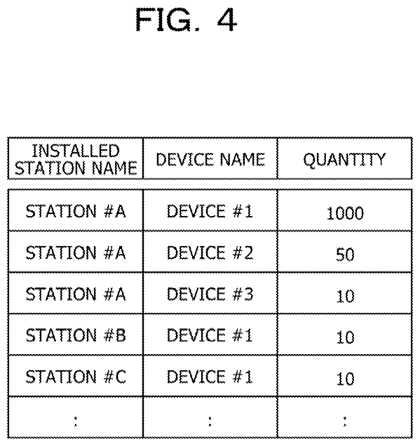

The asset management DB 111 stores a part of equipment information as asset data. The asset data is an example of third data. The part of equipment information is acquired from the equipment information DB 10 by the acquisition unit 121 and stored as the asset data. As illustrated in FIG. 4, the asset data includes a plurality of items such as an installed station name, a device name, and a quantity. For example, 1000 devices #1, 50 devices #2, and 10 devices #3 are installed in a station #A. The models of devices #1, #2, and #3 are different from each other. Differences in models and names are represented by a symbol “#” and distinguished from reference signs in this specification.

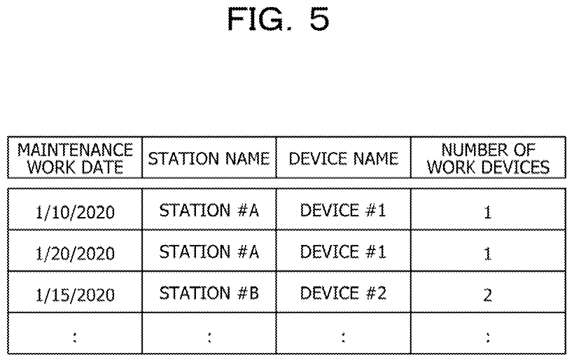

The maintenance result DB 112 stores a part of work information as maintenance data. The maintenance data is an example of first data. The part of work information is acquired from the work information DB 20 by the acquisition unit 121 and stored as the maintenance data. As illustrated in FIG. 5, the maintenance data includes a plurality of items such as a maintenance work date, a station name, a device name, and a number of work devices. For example, a maintenance work is performed on one of the devices #1 installed in the station #A on Jan. 10, 2020.

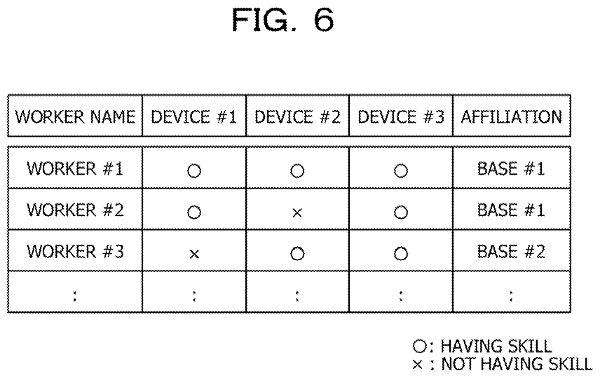

The possessing skill DB 113 stores a part of human resource information as skill data. The skill data is an example of second data. The part of human resource information is acquired from the human resource information DB 30 by the acquisition unit 121 and stored as the skill data. As illustrated in FIG. 6, the skill data includes a plurality of items such as a worker name of a maintenance worker who is a maintenance staff, a skill capable of handling the device #1, a skill capable of handling the device #2, a skill capable of handling the device #3, and an affiliation of the worker. For example, a worker #1 belongs to a base #1 and possesses a skill capable of handling all of the device #1, the device #2, and the device #3. A worker #2 belongs to the base #1 and possesses a skill capable of handling the device #1 and the device #3 but does not possess a skill capable of handling the device #2.

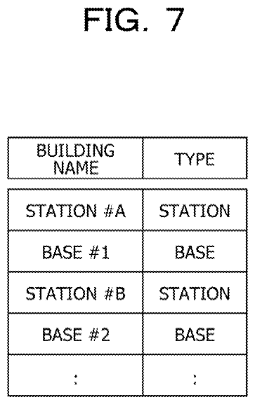

The building DB 114 stores a part of facility information as building data. The part of facility information is acquired from the facility information DB 40 by the acquisition unit 121 and stored as the building data. As illustrated in FIG. 7, the building data includes a plurality of items such as a building name that is a name of a building and a type of the building. The building includes both concepts of a building and a work station. For example, the type of the base #1 that is a building (for example, a work station) is a base, and the type of the station #A that is a building (for example, a building) is a station.

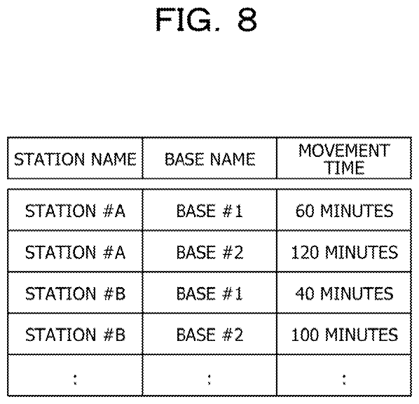

A part of movement information is stored as movement time data in the movement time DB 115. The movement time data is an example of fourth data. The part of movement information is acquired from the movement information DB 50 by the acquisition unit 121 and stored as the movement time data. As illustrated in FIG. 8, the movement time data includes a plurality of items such as a station name that is a name of a station, a base name that is a name of a base, and a movement time. For example, the movement time between the station #A and the base #1 is 60 minutes.

The acquisition unit 121 periodically accesses the equipment information DB 10 via the communication unit 150, acquires a part of the equipment information stored in the equipment information DB 10, and stores the acquired part of the equipment information as asset data in the asset management DB 111. Similarly, the acquisition unit 121 periodically accesses the work information DB 20 via the communication unit 150, acquires a part of the work information stored in the work information DB 20, and stores the acquired part of the work information as maintenance data in the maintenance result DB 112. The acquisition unit 121 periodically accesses the human resource information DB 30 via the communication unit 150, acquires a part of the human resource information stored in the human resource information DB 30, and stores the acquired part of the human resource information as skill data in the possessing skill DB 113. The acquisition unit 121 periodically accesses the facility information DB 40 via the communication unit 150, acquires a part of the facility information stored in the facility information DB 40, and stores the acquired part of the facility information as building data in the building DB 114. The acquisition unit 121 periodically accesses the movement information DB 50 via the communication unit 150, acquires a part of the movement information stored in the movement information DB 50, and stores the acquired part of the movement information as movement time data in the movement time DB 115.

From the input unit 130, the input and output unit 122 receives an execution request of processing input to the input apparatus 710. After receiving the execution request, the input and output unit 122 requests the distribution unit 123 to start distribution processing. Details of the distribution processing will be described later. When the end of calculation processing by the calculation unit 125 is notified, the input and output unit 122 generates a confirmation screen including processing result of the calculation processing. After generating the confirmation screen, the input and output unit 122 outputs the confirmation screen to the display apparatus 720 via the output unit 140.

The distribution unit 123 executes distribution processing. The distribution processing is processing of distributing each station such that each station is under the jurisdiction of the base with a shortest movement time, and generating a base-based station list in which stations are classified by the base, based on the building data and the movement time data. Details of the distribution processing will be described later.

The estimation unit 124 executes estimation processing. In the estimation processing, a target base that is a processing target is determined based on the building data, and a plurality of stations under jurisdiction of the target base are specified based on the determined target base and the base-based station list. In the estimation processing, based on the specified station, asset data, and maintenance data, a maintenance result of the station is specified for each station, and the maintenance result of the target base is specified. In the estimation processing, an operation prospect of the device at the target base is estimated based on the base-based maintenance result data including the number of maintenance results of the maintenance results at the specified target base and a predetermined estimation algorithm for estimating the operation prospect of the device, and model-based operation prospect data including the estimated operation prospect is generated. Details of the estimation processing will be described later.

The calculation unit 125 executes calculation processing. In the calculation processing, a target number of persons is calculated based on the model-based operation prospect data and a calculation algorithm for calculating the target number of persons requested for the base. Based on the skill data, in the calculation processing, a current number of persons who currently possess the skill for the model is calculated, and a desired number of persons, which is a difference between the target number of persons and the current number of persons is calculated. After calculating the desired number of persons in the calculation processing, number-of-persons data including the target number of persons, the current number of persons, and the desired number of persons is generated and transmitted to the input and output unit 122 as the processing result of the calculation processing, and the end of the calculation processing is notified.

An operation of the maintenance staff management apparatus 100 will be described next.

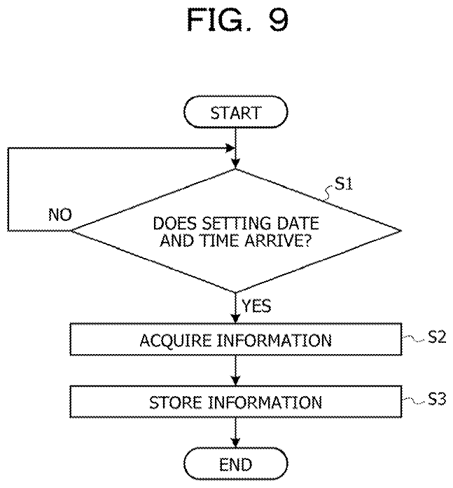

First, an operation of the acquisition unit 121 will be described with reference to FIG. 9. The acquisition unit 121 waits until a setting date and time (for example, midnight 0 o'clock or the like) arrives (step S1: NO). When the setting date and time arrives (step S1: YES), the acquisition unit 121 acquires information (step S2). For example, the acquisition unit 121 accesses the equipment information DB 10, the work information DB 20, and the like, and acquires a part of the equipment information, a part of the work information, and the like.

After acquiring the information, the acquisition unit 121 stores the acquired information (step S3). For example, the acquisition unit 121 stores the part of the equipment information as asset data in the asset management DB 111. The acquisition unit 121 stores the part of the work information as maintenance data in the maintenance result DB 112. Although the acquisition unit 121 also acquires a part of the human resource information, a part of the facility information, and a part of the movement information and stores them as data in the corresponding DB in the same manner, detailed description thereof will be omitted. By storing various pieces of data in the various DBs as described above, the maintenance staff management apparatus 100 may generate the number-of-persons data based on the stored data.

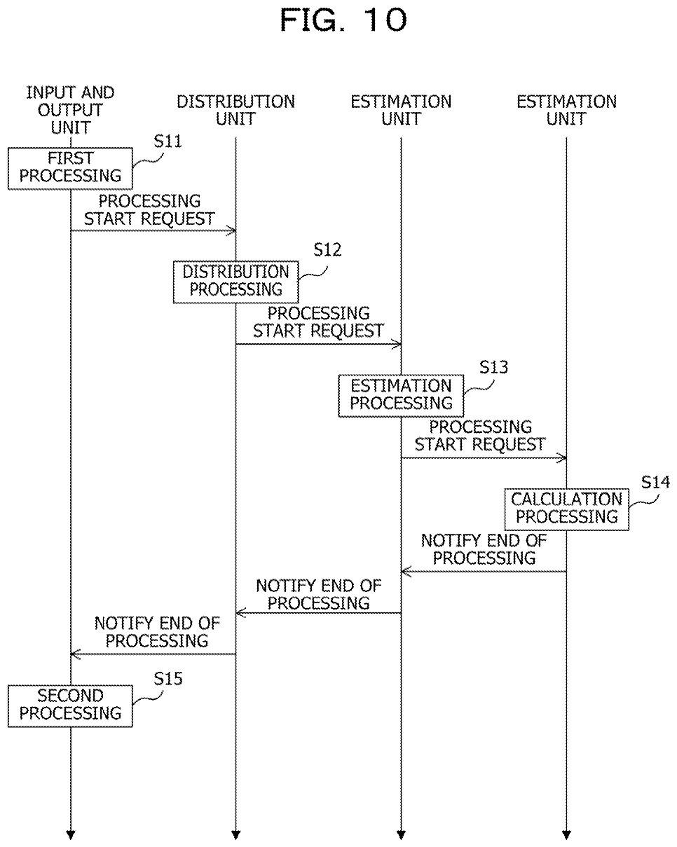

Each operation of the input and output unit 122, the distribution unit 123, the estimation unit 124, and the calculation unit 125 will be described next with reference to FIG. 10. Each operation of the input and output unit 122, the distribution unit 123, the estimation unit 124, and the calculation unit 125 is performed independently of the operation of the acquisition unit 121. For example, the input and output unit 122, the distribution unit 123, the estimation unit 124, and the calculation unit 125 operate in cooperation with each other, but the acquisition unit 121 operates without cooperation with the input and output unit 122, the distribution unit 123, the estimation unit 124, and the calculation unit 125.

First, the input and output unit 122 executes first processing (step S11). Although the details will be described later, the first processing is processing of receiving an execution request from the input apparatus 710 and requesting the distribution unit 123 to start distribution processing. Accordingly, when the first processing is ended, the distribution unit 123 executes the distribution processing described above (step S12). The distribution processing will be described in more detail later. When the distribution processing is ended, the distribution unit 123 requests the estimation unit 124 to start estimation processing.

Accordingly, the estimation unit 124 executes the estimation processing described above (step S13). The estimation processing will be described in more detail later. When the estimation processing is ended, the estimation unit 124 requests the calculation unit 125 to start calculation processing. Accordingly, the calculation unit 125 executes the calculation processing described above (step S14). The calculation processing will be described in more detail later. When the calculation processing is ended, the calculation unit 125 notifies the estimation unit 124 of the end of the calculation processing. When the end of the calculation processing is notified, the estimation unit 124 notifies the distribution unit 123 of the end of the calculation processing. When the end of the calculation processing is notified, the distribution unit 123 notifies the input and output unit 122 of the end of the calculation processing.

When the end of the calculation processing is notified, the input and output unit 122 executes second processing (step S15). Although the details will be described later, the second processing is processing of, when the end of the calculation processing is notified, acquiring the above-described number-of-persons data, and generating a confirmation screen including the number-of-persons data and outputting the confirmation screen to the display apparatus 720. When the second processing is ended, the maintenance staff management apparatus 100 ends the operation in cooperation with the input and output unit 122, the distribution unit 123, the estimation unit 124, and the calculation unit 125.

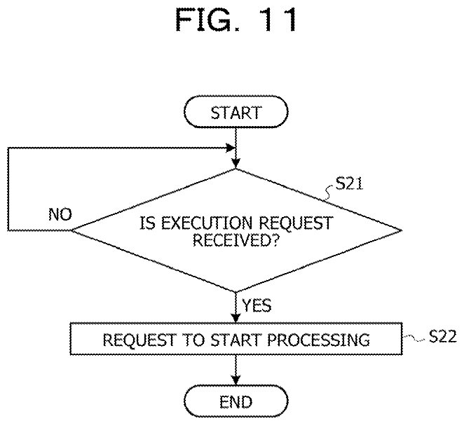

The first processing executed by the input and output unit 122 described above will be described next with reference to FIG. 11.

When the first processing is started, the input and output unit 122 waits until an execution request is received (step S21: NO). The execution request is output from the input apparatus 710 based on an operation by the user 60, and is received by the input unit 130. Accordingly, the input and output unit 122 waits until the execution request is received from the input unit 130. After receiving the execution request (step S21: YES), the input and output unit 122 requests the distribution unit 123 to start distribution processing (step S22), and ends the first processing. Accordingly, the distribution unit 123 starts the distribution processing.

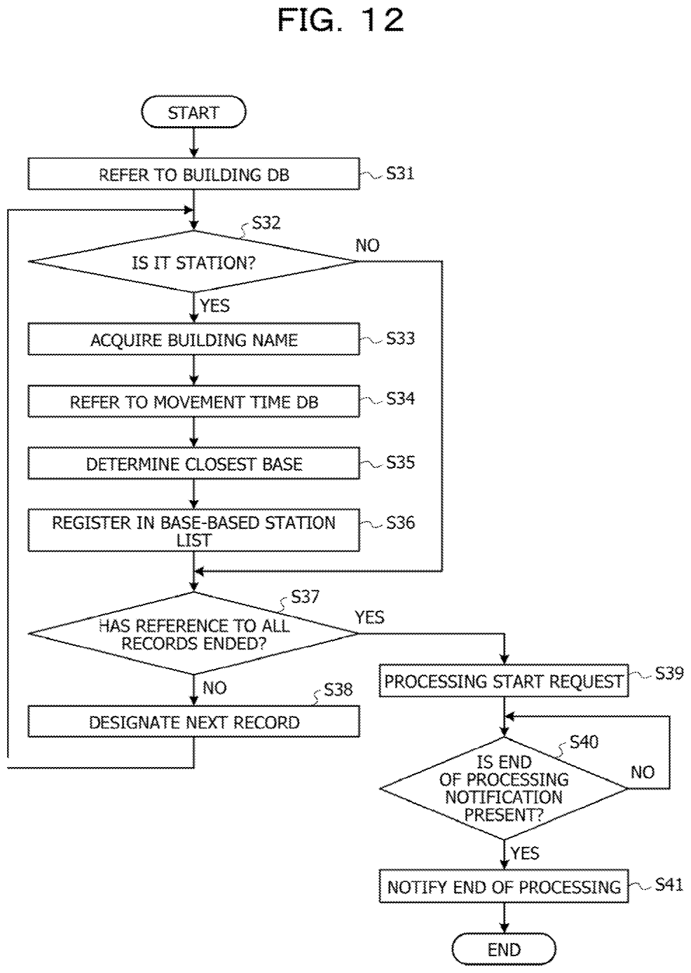

The distribution processing executed by the distribution unit 123 described above will be described next with reference to FIGS. 12 to 14.

As illustrated in FIG. 12, when the distribution processing is started, the distribution unit 123 refers to the building DB 114 (step S31). For example, the distribution unit 123 acquires and refers to a head record in the building data (see FIG. 7) stored in the building DB 114. After that, the distribution unit 123 determines whether a type of the referred record is a station (step S32). According to the building data of the present embodiment, since the type of the head record is a station, the distribution unit 123 determines that the type of the referred record is a station (step S32: YES).

In this case, the distribution unit 123 acquires a building name (step S33). For example, in the present embodiment, the distribution unit 123 acquires a station #A stored in the item of the building name in the head record. After acquiring the station #A as the building name, the distribution unit 123 then refers to the movement time DB 115 (step S34). For example, the distribution unit 123 acquires and refers to the movement time data (see FIG. 8) stored in the movement time DB 115. After referring to the movement time data, the distribution unit 123 determines a closest base based on the acquired building name (step S35). According to the present embodiment, regarding the station #A acquired by the distribution unit 123, the movement time between the station #A and the base #1 is 60 minutes, and the movement time between the station #A and a base #2 is 120 minutes. For this reason, the distribution unit 123 determines that the closest base to the station #A is the base #1.

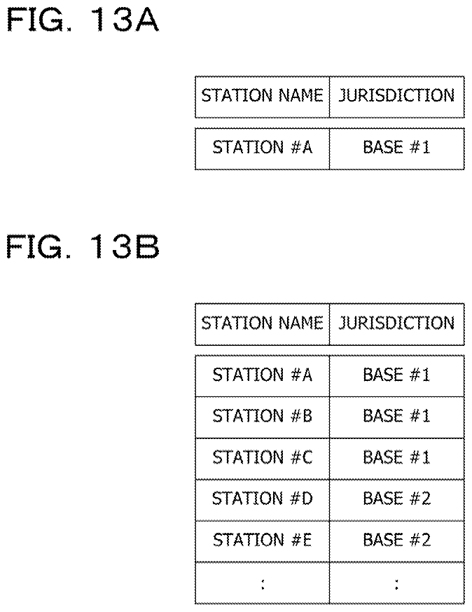

When the closest base is determined, the distribution unit 123 registers the acquired station name and the determined closest base in the base-based station list in association with each other (step S36). Accordingly, in the present embodiment, as illustrated in FIG. 13A, the distribution unit 123 registers the station #A and the base #1 in the base-based station list in association with each other. When a combination of the station name and the closest base is registered in the base-based station list, the distribution unit 123 determines whether reference to all records of the building data has ended (step S37).

When the reference to all the records of the building data has not ended (step S37: NO), the distribution unit 123 designates a next record of the building data (step S38), and the processing returns to the processing of step S32. According to the building data of the present embodiment, since a type of the next record is a base (see FIG. 7), the distribution unit 123 determines that the type of the referenced record is not a station (step S32: NO). In this case, the distribution unit 123 skips the processing from step S33 to step S36.

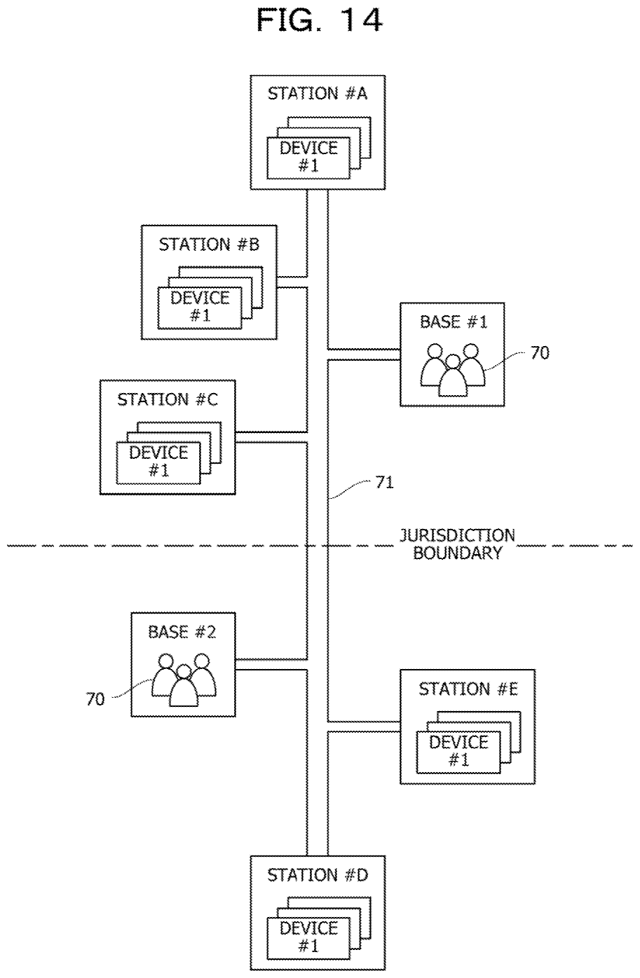

By repeating the processing from step S32 to step S38 in this manner, as illustrated in FIG. 13B, all the station names and the base names of all the bases closest to each station are registered in the base-based station list in association with each other. For example, as illustrated in FIG. 14, the base-based station list is completed in accordance with a relationship between actual locations of the stations #A to #E in which the device #1 and the like are installed and the base #1 and the base #2 where a maintenance staff 70 stays or waits. According to the base-based station list, the base #1 has jurisdiction over the stations #A to #C, and the base #2 has jurisdiction over the stations #D and #E.

For this reason, as illustrated in FIG. 14, it is possible to virtually define a jurisdiction boundary between the base #1 and the base #2, the jurisdiction boundary being a boundary of each jurisdiction. The stations #A to #E are joined to the base #1 and the base #2 via a movement route 71 including roads. For this reason, for example, the maintenance staff 70 at the base #1 moves along the movement route 71 toward the stations #A to #C, and may perform a maintenance work on the device #1 and the like installed in the stations #A to #C. Similarly, the maintenance staff 70 at the base #2 moves along the movement route 71 toward the station #D and the station #E, and may perform a maintenance work on the device #1 and the like installed in the station #D and the station #E. The stations #A to #E, the base #1, and the base #2 are managed by the company described above. The equipment information DB 10, the work information DB 20, the maintenance staff management apparatus 100, and the like described above may be provided at the base #1 or the base #2, or may be provided at a base (not illustrated) such as a head office of the company different from the base #1 or the base #2.

Returning to FIG. 12, in a case where the reference to all the records of the building data has ended (step S37: YES), the distribution unit 123 requests the estimation unit 124 to start estimation processing (step S39), and waits until the end of processing is notified from the estimation unit 124 (step S40: NO). When the end of processing is notified from the estimation unit 124 (step S40: YES), the distribution unit 123 transfers the end of processing to the input and output unit 122 (step S41) and ends the distribution processing.

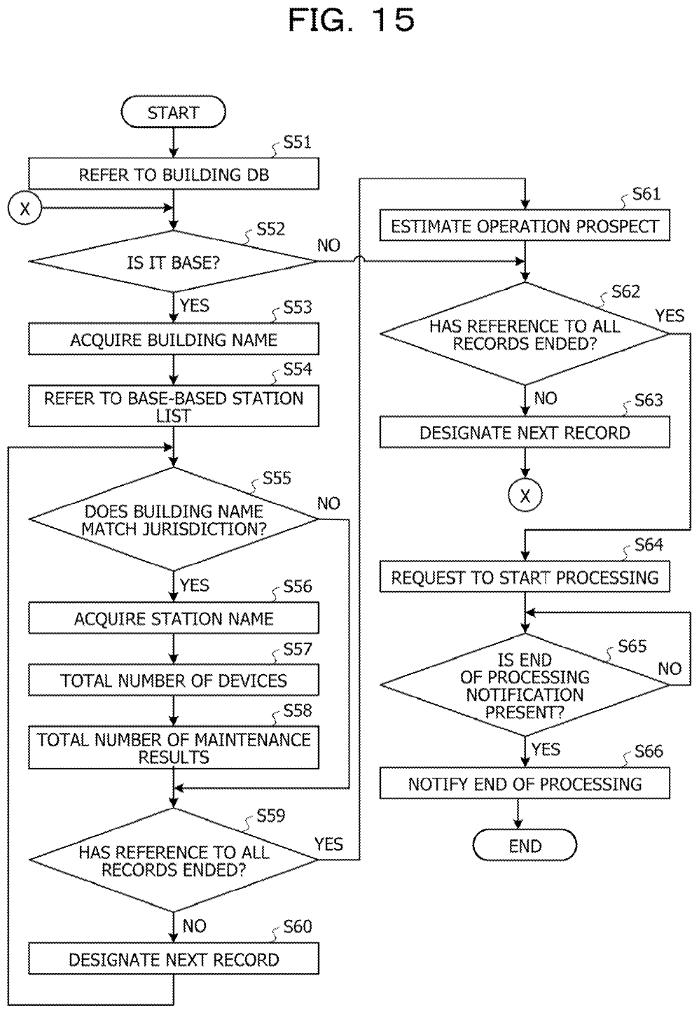

The estimation processing executed by the estimation unit 124 described above will be described next with reference to FIGS. 15 to 17.

As illustrated in FIG. 15, when the estimation processing is started, the estimation unit 124 refers to the building DB 114 (step S51). For example, the estimation unit 124 acquires and refers to a head record in the building data (see FIG. 7) stored in the building DB 114. After that, the estimation unit 124 determines whether a type of the referred record is a base (step S52). According to the building data of the present embodiment, since the type of the head record is a station, the estimation unit 124 determines that the type of the referred record is not a base (step S52: NO).

In this case, the estimation unit 124 skips the processing from step S53 to step S61, which will be described later, and determines whether reference to all records of the building data has ended (step S62). In a case where the reference to all the records of the building data has not ended (step S62: NO), the estimation unit 124 designates a next record of the building data (step S63), and the processing returns to the processing of step S52. According to the building data of the present embodiment, since the type of the next record is a base (see FIG. 7), the estimation unit 124 determines that the type of the referred record is a base (step S52: YES).

In this case, the estimation unit 124 acquires the building name (step S53). For example, in the present embodiment, the estimation unit 124 acquires a base #1 stored in the item of the building name in the next record from the head. When the base #1 is acquired as the building name, the estimation unit 124 then refers to the base-based station list (see FIG. 13B) (step S54). For example, the estimation unit 124 acquires and refers to the head record in the base-based station list. By referring to the head record in the base-based station list, the estimation unit 124 determines whether the acquired building name matches the jurisdiction (step S55). According to the present embodiment, as described above, the estimation unit 124 acquires the base #1 as the building name. On the other hand, the base #1 is registered in the jurisdiction of the head record in the base-based station list. For this reason, the estimation unit 124 determines that the acquired building name matches the jurisdiction (step S55: YES).

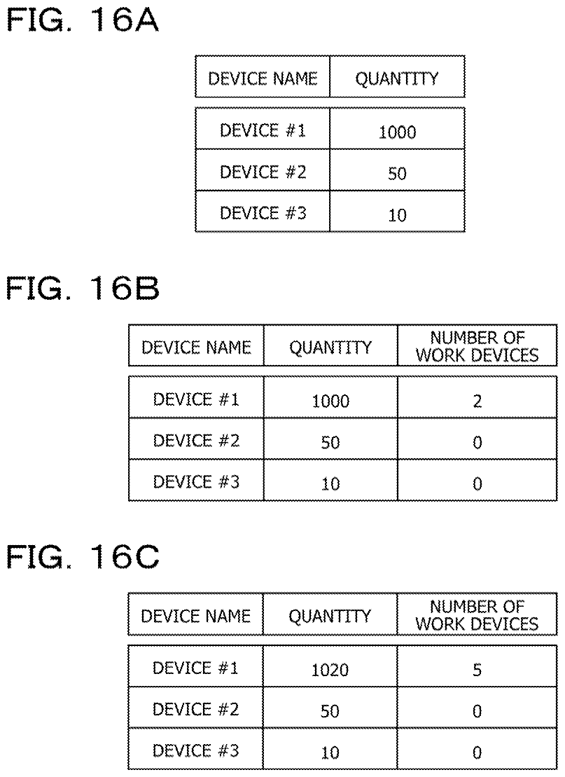

In this case, the estimation unit 124 acquires a station name from the base-based station list (step S56). According to the present embodiment, the estimation unit 124 acquires a station #A associated with the base #1 registered in the jurisdiction of the head record in the base-based station list (see FIG. 13B). After acquiring the station name, the estimation unit 124 totals the number of devices (step S57). For example, the estimation unit 124 specifies a record including the acquired station name from the asset data (see FIG. 4), and generates first intermediate data obtained by totaling the number of devices registered in the quantity of the specified record as the number of devices for each device. By using the first intermediate data, as illustrated in FIG. 16A, the numbers of the device #1, the device #2, and the device #3 installed in the station #A of the base #1 are specified.

After totaling the number of devices, the estimation unit 124 totals the number of maintenance results (step S58). For example, the estimation unit 124 acquires maintenance data (see FIG. 5) by referring to the maintenance result DB 112, and specifies a record including the acquired station name from the acquired maintenance data. The estimation unit 124 generates second intermediate data obtained by totaling the number of work devices registered in the item of the number of work devices of the specified record as the number of maintenance results for each device. By using the second intermediate data, as illustrated in FIG. 16B, the numbers of results of the maintenance work performed on the device #1, the device #2, and the device #3 installed in the station #A of the base #1 are specified.

When the building name does not match the jurisdiction (step S55: NO) or when the number of maintenance results is totaled, the estimation unit 124 determines whether reference to all records in the base-based station list has ended (step S59). In a case where the reference to all the records of the base-based station list has not ended (step S59: NO), the estimation unit 124 designates a next record of the base-based station list (step S60), and the processing returns to the processing of step S55. By repeating the processing from step S55 to step S60 in this manner, as illustrated in FIG. 16C, the estimation unit 124 generates and holds the base-based maintenance result data including, for each device, the total number of devices and the total number of maintenance results of the base #1 that has jurisdiction over the station #A, the station #B, and the station #C.

Returning to FIG. 15, in a case where the reference to all the records of the base-based station list has ended (step S59: YES), the estimation unit 124 estimates an operation prospect (step S61). For example, the estimation unit 124 estimates the operation prospect for each device based on the above-described base-based maintenance result data and a predetermined estimation algorithm. The predetermined estimation algorithm is an algorithm that adopts, as the operation prospect, one having a larger number of calculation results calculated from the number of work devices in the base-based maintenance result data and a standard operation rate determined by design or setting.

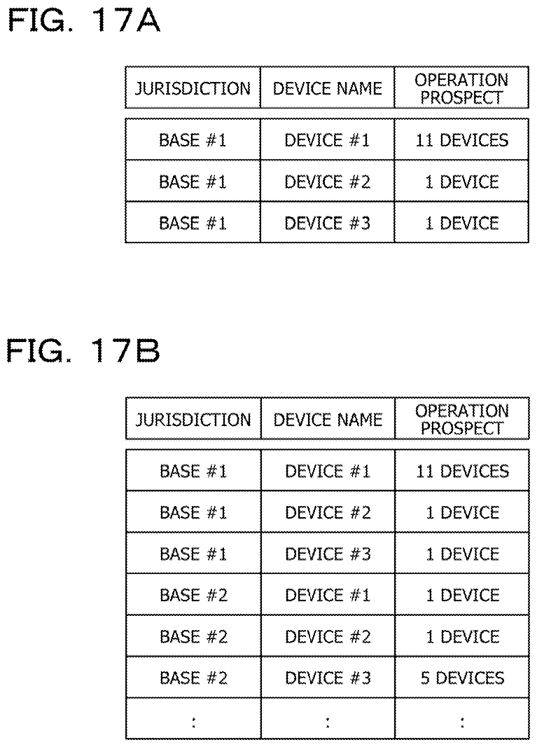

According to the base-based maintenance result data according to the present embodiment, the number of work devices of the device #1 of the base #1 is five. On the other hand, when the standard operation rate is set to 1%, the calculation result is 11 (=1020×0.01 (rounded up after the decimal point)) because the number of devices of the device #1 of the base #1 is 1020 according to the base-based maintenance result data according to the present embodiment. For this reason, for the device #1, the estimation algorithm adopts the calculation result of 11 devices as the operation prospect, instead of the number of work devices of five devices. For the devices #2 and #3, the estimation algorithm estimates the operation prospect in the same manner. Accordingly, as illustrated in FIG. 17A, the estimation unit 124 generates and holds model-based operation prospect data for the base #1.

After estimating the operation prospect, the estimation unit 124 executes the processing of step S62 and determines whether the reference to all the records of the building data has ended. When all the records of the building data are not referred to, the estimation unit 124 executes the processing of step S63, and returns to the processing of step S52. By repeating the processing from step S52 to step S60, as illustrated in FIG. 17B, the estimation unit 124 generates and holds the model-based operation prospect data for all the bases.

Returning to FIG. 15, in a case where the reference to all the records of the building data has ended (step S62: YES), the estimation unit 124 requests the calculation unit 125 to start the calculation processing (step S64), and waits until the end of processing is notified from the calculation unit 125 (step S65: NO). After the end of processing is notified from the calculation unit 125 (step S65: YES), the estimation unit 124 transfers the end of processing to the distribution unit 123 (step S66) and ends the estimation processing.

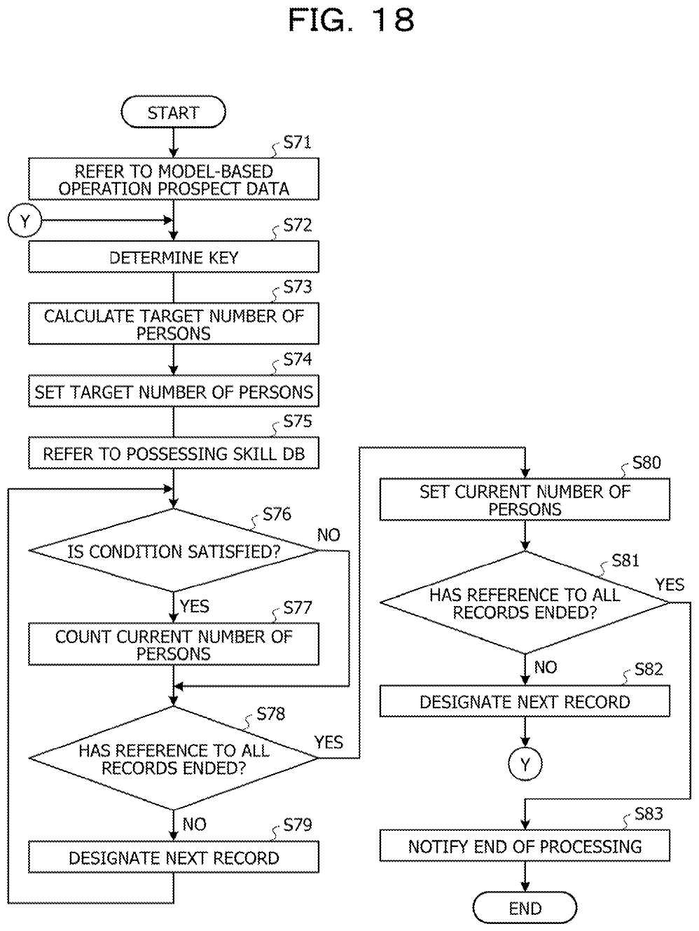

The calculation processing executed by the calculation unit 125 described above will be described next with reference to FIGS. 18 to 20.

As illustrated in FIG. 18, when the calculation processing is started, the calculation unit 125 refers to the model-based operation prospect data described above (step S71). For example, the calculation unit 125 acquires and refers to a head record of the model-based operation prospect data held by the estimation unit 124. After that, the calculation unit 125 determines a key of the referred record (step S72). For example, the calculation unit 125 determines a combination of the jurisdiction and the device of the referred record as the key. According to the present embodiment, since the base #1 and the device #1 are registered in the head record of the model-based operation prospect data (see FIG. 17B), the calculation unit 125 determines the combination of the base #1 and the device #1 as the key.

After determining the key, the calculation unit 125 calculates a target number of persons (step S73). For example, the calculation unit 125 calculates the target number of persons based on the operation prospect of the model-based operation prospect data associated with the determined key and a predetermined calculation algorithm. The predetermined calculation algorithm is an algorithm for calculating the target number of persons in accordance with the operation prospect based on a proportional relationship between the operation prospect and the target number of persons. For example, in a case where a standard for disposing one maintenance staff per ten devices is provided, the calculation algorithm is defined as the target number of persons=operation prospect/10, or the target number of persons=0.1×operation prospect (both are rounded up after the decimal point). According to the model-based operation prospect data according to the present embodiment, 11 devices are registered as the operation prospect in the key that is the combination of the base #1 and the device #1 (see FIG. 17B). For this reason, the calculation unit 125 calculates two persons (=11/10 (rounded up after the decimal point)) as the target number of persons based on the calculation algorithm.

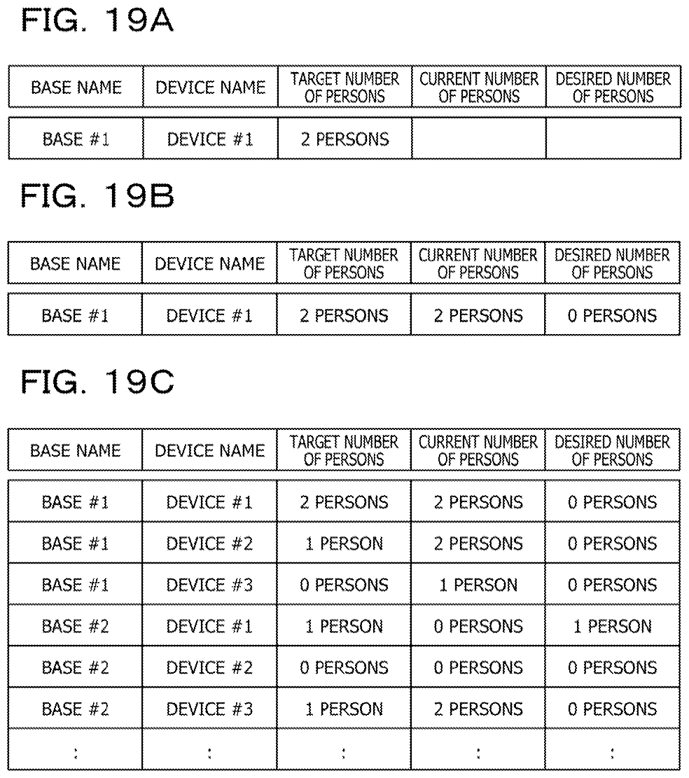

After calculating the target number of persons, the calculation unit 125 sets the target number of persons in the number-of-persons data (step S74). Accordingly, as illustrated in FIG. 19A, the calculation unit 125 generates and holds the number-of-persons data in which two persons are set as the target number of persons in the key that is the combination of the base #1 and the device #1.

After the target number of persons is set, the calculation unit 125 refers to the possessing skill DB 113 (step S75). For example, the calculation unit 125 acquires and refers to a head record of the skill data (see FIG. 6) stored in the possessing skill DB 113. After referring to the head record of the skill data, the calculation unit 125 determines whether a predetermined condition is satisfied for a target key (step S76). The predetermined condition is that a jurisdiction registered in the number-of-persons data and an affiliation of a worker registered in the skill data match, and the worker possesses a skill capable of handling the device registered in the number-of-persons data. According to the present embodiment, a base #1 is registered as the jurisdiction and a device #1 is registered as the device in the number-of-persons data (see FIG. 19A). On the other hand, according to the skill data, the worker #1 registered in the head record belongs to the base #1 and possesses a skill capable of handling the device #1 (see FIG. 6). Since the jurisdiction and the affiliation match at the base #1 and the worker #1 possesses the skill capable of handling the device #1, the calculation unit 125 determines that the predetermined condition is satisfied for the target key (step S76: YES).

In this case, the calculation unit 125 counts the current number of persons (step S77). At this stage, since the worker #1 is one person, the calculation unit 125 counts the current number of persons as one person. In a case where the predetermined condition is not satisfied (step S76: NO), the calculation unit 125 skips the processing of step S77. When the predetermined condition is not satisfied or when the current number of persons is counted, the calculation unit 125 determines whether reference to all records of the skill data has ended (step S78). When the reference to all the records of the skill data has not ended (step S78: NO), the calculation unit 125 designates a next record of the skill data (step S79), and the processing returns to the processing of step S76. Accordingly, in the present embodiment, the same processing is repeated for the worker #2 registered in the skill data. Since the worker #2 also belongs to the base #1 and possesses the skill capable of handling the device #1 (see FIG. 6), one person for the worker #2 is also added to one person for the worker #1, and the current number of persons is two persons.

When the reference to all the records of the skill data has ended (step S78: YES), the calculation unit 125 sets the current number of persons in the number-of-persons data (step S80). Accordingly, as illustrated in FIG. 19B, the calculation unit 125 generates and holds the number-of-persons data in which two persons are set as the current number of persons in the key that is the combination of the base #1 and the device #1. The calculation unit 125 sets, in the number-of-persons data, a desired number of persons obtained by subtracting the current number of persons from the target number of persons based on a predetermined calculation formula. For example, the predetermined calculation formula is, the desired number of persons=the target number of persons—the current number of persons. As described above, the calculation unit 125 calculates a number of insufficient persons for the target key, and sets the calculated number as the desired number of persons.

After the current number of persons is set, the calculation unit 125 determines whether reference to all records of the model-based operation prospect data has ended (step S81). When the reference to all the records of the model-based operation prospect data has not ended (step S81: NO), the calculation unit 125 designates a next record of the model-based operation prospect data (step S82), and the processing returns to the processing of step S72. Accordingly, in the present embodiment, the calculation unit 125 determines a combination of the base #1 and the device #2 registered in a next record from the head in the model-based operation prospect data as a key, and repeats the processing from step S72 to step S80. As a result, as illustrated in FIG. 19C, the calculation unit 125 generates and holds the number-of-persons data including the target number of persons, the current number of persons, and the desired number of persons for each base for all the models of devices. According to the present embodiment, as illustrated in FIG. 19C, a case where the desired number of persons is a negative number is set as 0 persons, but the negative number may be set as it is. In this case, it means that the current number of persons is surplus with respect to the target number of persons.

When the reference to all the records of the model-based operation prospect data has ended (step S81: YES), the calculation unit 125 notifies the estimation unit 124 of the end of processing of the calculation processing (step S83) and ends the calculation processing. Accordingly, the estimation unit 124 notifies the distribution unit 123 of the end of processing of the calculation processing by the calculation unit 125, and the distribution unit 123 notifies the input and output unit 122 of the end of processing of the calculation processing by the calculation unit 125.

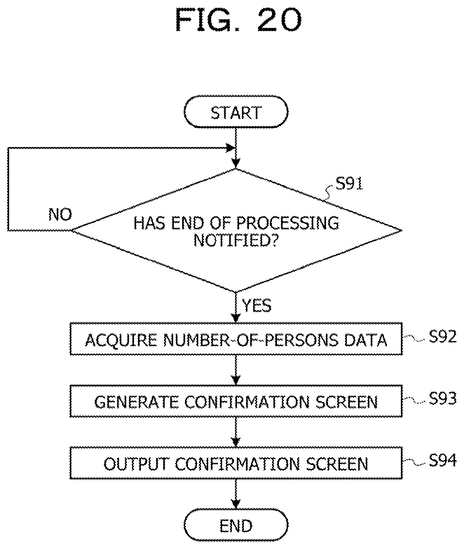

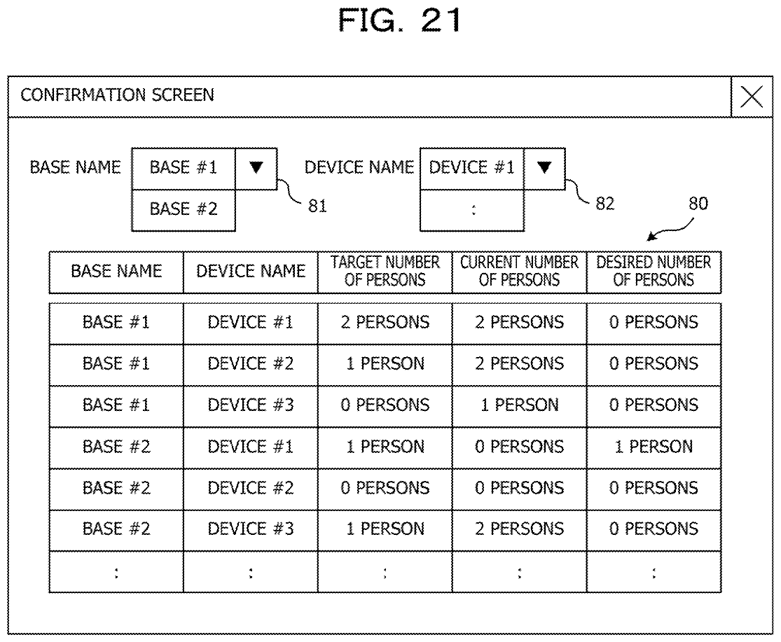

The second processing executed by the input and output unit 122 described above will be described next with reference to FIGS. 20 and 21.

When the second processing is started, the input and output unit 122 waits until the end of processing is notified (step S91: NO). As described above, the distribution unit 123 notifies the input and output unit 122 of the end of processing. When the end of processing is notified (step S91: YES), the input and output unit 122 acquires the number-of-persons data from the calculation unit 125 (step S92) and generates a confirmation screen (step S93). As illustrated in FIG. 21, the confirmation screen includes number-of-persons data 80. A display field of the number-of-persons data 80 may display the target number of persons, the current number of persons, and the desired number of persons for each device at each base. Based on the data of the desired number of persons for each device at each base, the skill data (see FIG. 6) may reflect information on the skill for the device recommended to be possessed by the maintenance staff who may be disposed as one of the desired number of persons. For example, data for prompting a worker #3 in the skill data to learn the skill for the device #1 at the base #2 may be generated and output to the display apparatus 720. The confirmation screen includes a selection button 81 for selecting a base name to be displayed and a selection button 82 for selecting a device name to be displayed. When the confirmation screen is generated, the input and output unit 122 outputs the confirmation screen to the display apparatus 720 (step S94), and the second processing is ended.

By viewing the confirmation screen displayed on the display apparatus 720, the user 60 may clearly grasp the maintenance staff possessing a skill requested at each base for each model. As a result, the user 60 may make a plan for appropriately disposing the maintenance staff desired at each base, and may perform support to the maintenance staff for possessing the skill as desired. Since the maintenance staff does not necessarily have to possess a skill capable of handling all the devices, it is possible to reduce time and cost until the maintenance staff possesses the skill.

### Second Embodiment

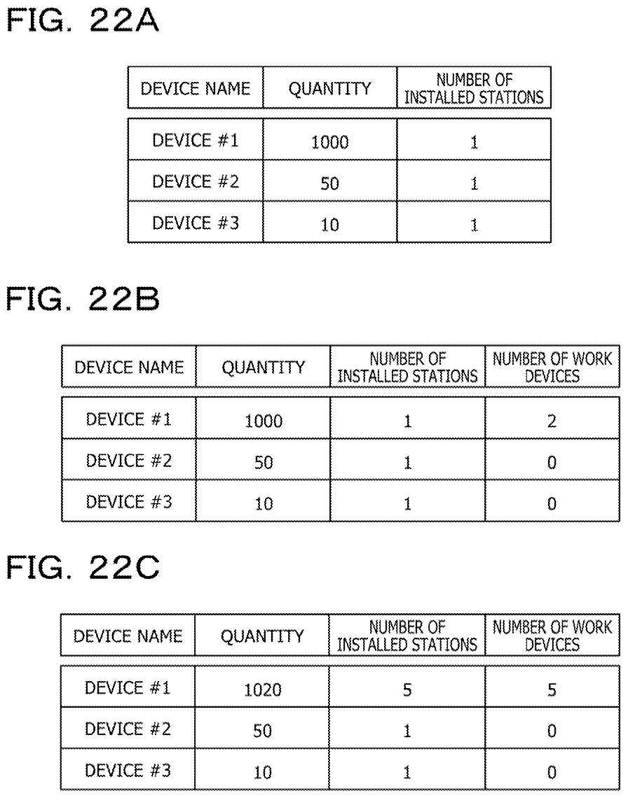

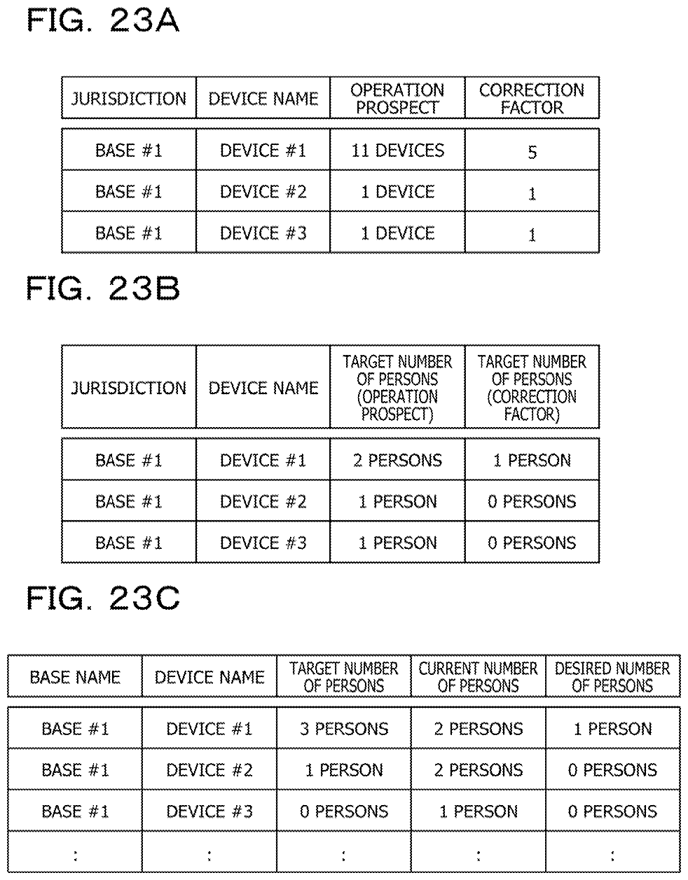

Subsequently, with reference to FIGS. 22A to 23C, a second embodiment of the present disclosure will be described. According to the first embodiment, the method of calculating the target number of persons based on the operation prospect has been described. However, in a case where simultaneous occurrence of failures of devices is taken into consideration, there is room for improvement in the method of calculating the target number of persons by using the operation prospect alone. For this reason, in the second embodiment, a calculation example of the target number of persons in consideration of the simultaneous occurrence of failures will be described.

Even when the quantity of devices at the same base is the same, in a case where the devices are installed in a specific station in a centralized manner and in a case where the devices are installed in a plurality of stations in a distributed manner, it is desirable that the maintenance staff be increased in the latter case in preparation for the simultaneous occurrence of failures. Such a case may also be improved by adding data handled in the processing described in the first embodiment.

For example, in the first embodiment, with reference to FIG. 16A, it has been described that the numbers of devices of the device #1, the device #2, and the device #3 installed in the station #A of the base #1 are specified. However, in the second embodiment, as illustrated in FIG. 22A, the estimation unit 124 totals and specifies a number of installed stations together with the total number of devices. According to the first embodiment, with reference to FIG. 16B, it has been described that the numbers of results of the maintenance work performed on the device #1, the device #2, and the device #3 installed in the station #A of the base #1 are specified. However, in the second embodiment, as illustrated in FIG. 22B, the estimation unit 124 totals and specifies the number of installed stations together with the total number of maintenance results.

According to the first embodiment, with reference to FIG. 16C, it has been described that the estimation unit 124 generates and holds the base-based maintenance result data including, for each device, the total number of devices and the total number of maintenance results of the base #1 that has jurisdiction over the station #A, the station #B, and the station #C. However, in the second embodiment, as illustrated in FIG. 22C, the estimation unit 124 generates and holds the base-based maintenance result data including, for each device, the total number of devices, the total number of maintenance results, and the total number of installed stations of the base #1 that has jurisdiction over the station #A, the station #B, and the station #C. As illustrated in FIG. 23A, the estimation unit 124 generates and holds the model-based operation prospect data for the base #1 for which the number of installed stations is set as a correction factor, based on the total number of installed stations of the base-based maintenance result data according to the second embodiment.

According to the first embodiment, it has been described that a reference for disposing one maintenance staff per ten devices is provided, and the calculation unit 125 calculates two persons as the target number of persons based on the calculation algorithm including the reference. According to the second embodiment, the calculation unit 125 adds the target number of persons based on the correction factor of the number of installed stations. For example, in a case where one maintenance staff is increased for five installed stations, the calculation unit 125 adds the target number of persons based on the correction factor to the target number of persons based on the operation prospect. The target number of persons based on the correction factor is defined by, for example, the target number of persons=correction factor/5 (rounded down after the decimal point).

Accordingly, when a numerical value of the correction factor is 5, as illustrated in FIG. 23B, the target number of persons based on the correction factor is one person. As illustrated in FIG. 23B, when the numerical value of the correction factor is 1, the target number of persons based on the correction factor is 0. Accordingly, as illustrated in FIG. 23C, for example, the target number of persons with the combination of the base #1 and the device #1 as a key is three persons, and the desired number of persons obtained by subtracting the current number of persons from the target number of persons is one person.

As described above, according to the second embodiment, it is possible to calculate the target number of persons in consideration of the simultaneous occurrence of failures of devices. Although the number of installed stations is adopted as the correction factor in the second embodiment, the total number of devices may be adopted as the correction factor, or each of the number of installed stations and the total number of devices may be considered as the correction factor.

Although the preferred embodiment of the present disclosure has been described in detail above, the present disclosure is not limited to the specific embodiment according to the present disclosure, and various modifications and changes may be made within a scope of the gist of the present disclosure described in the claims.

For example, in the above-described embodiment, it has been described that the maintenance staff management apparatus 100 outputs the confirmation screen to the display apparatus 720 based on the execution request of the user 60. However, regardless of the execution request from the user 60, the maintenance staff management apparatus 100 may dynamically output the confirmation screen to the display apparatus 720 every time a predetermined setting date and time or a setting time arrives.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A maintenance staff management apparatus comprising:
one or more memories; and
one or more processors coupled to the one or more memories and the one or more processors configured to:
acquire first data including maintenance results of different models of devices installed in a plurality of stations under jurisdiction of a plurality of bases for each base,
acquire second data including a skill possessed by a maintenance staff of the device for the model,
acquire a number of persons of the maintenance staff for each of the bases desired for maintenance of the device based on the maintenance results and the skill, and
output the number of persons to a display apparatus as data associated with a combination of the device and the base.

2. The maintenance staff management apparatus according to claim 1, wherein the one or more processors are further configured to
acquire the number of persons based on the maintenance results, the skill, and a certain formula for acquiring the number of persons of the maintenance staff for each of the bases.

3. The maintenance staff management apparatus according to claim 1, wherein the one or more processors are further configured to:
acquire third data including a quantity of the device for each of the stations, and
acquire the number of persons based on the quantity.

4. The maintenance staff management apparatus according to claim 1, wherein the one or more processors are further configured to:
acquire fourth data including a movement time between the base and the station, and
acquire the number of persons based on the movement time.

5. The maintenance staff management apparatus according to claim 1, wherein
the device is an optical communication device.

6. The maintenance staff management apparatus according to claim 1, wherein the one or more processors are further configured to:
acquire a number of results of the maintenance results,
estimate an operation prospect of the device based on the acquired number of results,
acquire a target number of persons of the maintenance staff disposed at the base, based on the estimated operation prospect and a certain algorithm for acquiring the target number of persons of the maintenance staff disposed at the base,
count a current number of persons of the maintenance staff possessing the skill for each base, and
acquire the number of persons of the maintenance staff for each of the bases, based on the current number and the target number of persons.

7. The maintenance staff management apparatus according to claim 6, wherein the one or more processors are further configured to:
count a number of stations in which the device is installed, and
correct the target number of persons based on the counted number of stations.

8. The maintenance staff management apparatus according to claim 6, wherein the one or more processors are further configured to:
count a total number of the devices, and
correct the target number of persons based on the counted total number.

9. The maintenance staff management apparatus according to claim 6, wherein the one or more processors are further configured to:
count each of a number of stations in which the device is installed and a total number of the devices, and
correct the target number of persons based on the counted number of stations and the counted total number.

10. A maintenance staff management method for a computer to execute a process comprising:
acquiring first data including maintenance results of different models of devices installed in a plurality of stations under jurisdiction of a plurality of bases for each base;
acquiring second data including a skill possessed by a maintenance staff of the device for the model;
acquiring a number of persons of the maintenance staff for each of the bases desired for maintenance of the device based on the maintenance results and the skill; and
outputting the number of persons to a display apparatus as data associated with a combination of the device and the base.

11. The maintenance staff management method according to claim 10, wherein the process further comprising
acquiring the number of persons based on the maintenance results, the skill, and a certain formula for acquiring the number of persons of the maintenance staff for each of the bases.

12. The maintenance staff management method according to claim 10, wherein the process further comprising:
acquiring third data including a quantity of the device for each of the stations; and
acquiring the number of persons based on the quantity.

13. The maintenance staff management method according to claim 10, wherein the process further comprising:
acquiring fourth data including a movement time between the base and the station; and
acquiring the number of persons based on the movement time.

14. The maintenance staff management method according to claim 10, wherein
the device is an optical communication device.

15. The maintenance staff management method according to claim 10, wherein the one or more processors are further configured to:
acquiring a number of results of the maintenance results;
estimating an operation prospect of the device based on the acquired number of results;
acquiring a target number of persons of the maintenance staff disposed at the base, based on the estimated operation prospect and a certain algorithm for acquiring the target number of persons of the maintenance staff disposed at the base;
counting a current number of persons of the maintenance staff possessing the skill for each base; and
acquiring the number of persons of the maintenance staff for each of the bases, based on the current number and the target number of persons.

16. The maintenance staff management method according to claim 15, wherein the process further comprising:
counting a number of stations in which the device is installed; and
correcting the target number of persons based on the counted number of stations.

17. The maintenance staff management method according to claim 15, wherein the process further comprising:
counting a total number of the devices; and
correcting the target number of persons based on the counted total number.

18. The maintenance staff management method according to claim 15, wherein the process further comprising:
counting each of a number of stations in which the device is installed and a total number of the devices; and
correcting the target number of persons based on the counted number of stations and the counted total number.

19. A non-transitory computer-readable storage medium storing a maintenance staff management program that causes at least one computer to execute a process, the process comprising:
acquiring first data including maintenance results of different models of devices installed in a plurality of stations under jurisdiction of a plurality of bases for each base;
acquiring second data including a skill possessed by a maintenance staff of the device for the model;
acquiring a number of persons of the maintenance staff for each of the bases desired for maintenance of the device based on the maintenance results and the skill; and
outputting the number of persons to a display apparatus as data associated with a combination of the device and the base.
